(19) United States
(12) Patent Application Publication
(10) Pub. No.: US 2006/0218186 A1
(43) Pub. Date: Sep. 28, 2006

(54) Automated data processing using optical character recognition

(75) Inventor: Ramin Bagheri, Schwetzingen (DE)

Correspondence Address: KENYON & KENYON LLP, ONE BROADWAY, NEW YORK, NY, 10004, US

(73) Assignee: SAP Aktiengesellschaft

(21) Appl. No.: 11/088,085

(22) Filed: Mar. 23, 2005

(51) Int. Cl. G06F 7/00

(52) U.S. Cl. 707/104.1; 707/204

(57) ABSTRACT

Document processing may be effectively automated using OCR software in conjunction with varying processing elements. Incoming documents are received through one or more central locations. The documents are then retrieved from this central location and examined using OCR software, extracting the contents of the document. If the accuracy of the document is verified and all elements are found to be legible, the data and original document may be provided to a database access device. The database access device is in operative communication with a database containing reference information associated with the users operations. Along with the information, the original document, in electronic format, is also archived and associated with the proper file. This information, being stored in the database, is accessible by a data management system, such as a data processing application for using the data originally disposed in electronic format on the incoming document.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND OF THE INVENTION

The present invention relates generally to document processing and more specifically to using optical character recognition for automatic document processing.

Data processing of documentation can be a time consuming and labor intensive task. Not only does it require the handling of physical documents, but also physical data entry transcribing numbers from the documents into data processing systems. With the physical data entry, this may be prone to user error and can also be expensive to pay employees to simply transfer information between the physical form and the computing system.

Many incoming documents are received via a facsimile. These documents are already in electronic format and converted into a physical format by being printed out on paper. Other communication techniques include electronic mail with documents either imbedded in the electronic mail or included as attachments. A third alternative is the delivery of the physical documents, such as using a mailing service.

Current optical character recognition (OCR) technology allows for the recognition of characters within an electronically formatted document. For example with a physical document, the document may be scanned-in to create the electronic format. The facsimile and incoming electronic mail attachment may already be in an electronic format.

Using existing OCR technology, the elements within the electronic formatted documents are recognized. Further advancements in OCR technology allow for imparting an understanding of the recognized elements. In some existing systems, after the elements in the document have been recognized, they are examined for a particular purpose, such as reference numbers or other identifying features. For example, if the document is a purchase order, the recognition technology may parse out the customer number or information, a purchase order number, order elements and other information, such as technology current available from Seeburger Technologies, Inc. Although, the existing technology is limited in its usefulness based on the inability to process the recognized information. While the OCR technology can recognized and parse out the information, it cannot associate the information in any specifically formatted storage location, such as a database. Rather, this technology is limited to recognizing and parsing the information.

Different data management systems rely in large part on the central database structures. For example, enterprise resource programs (ERPs) allow numerous users to directly access database information for a variety of different purposes. One important aspect to database management applications is the data in the database itself. As described above, it is inefficient to manually enter this information. Therefore, it would be extremely beneficial to utilize existing OCR technology for importing input information into the database.

### BRIEF DESCRIPTION OF THE DRAWINGS

FIG. 1 illustrates a block diagram of one embodiment of an automated system for data processing using OCR.

FIG. 2 illustrates a representation of one embodiment of an input document in an automated system allowing for data processing using OCR.

FIG. 3 illustrates a representative screen shot of one embodiment of a data field within the system allowing for automated data processing using OCR.

FIG. 4 illustrates a block diagram of a system accessing the database in the automated system allowing for data processing using OCR.

FIG. 5 illustrates the steps of an embodiment of a method for automated data processing using OCR.

### DETAILED DESCRIPTION

Generally, document processing may be effectively automated using OCR software in conjunction with varying processing elements. Incoming documents are received through one or more central locations. The documents are examined using OCR software, extracting the contents of the document. Upon verification of the information, the data and original document may be provided to a database access device, which is in communication with a database. Using the information extracted from document as a reference, the information and the electronic document are then imported into the database for use by a data management system accessing the database.

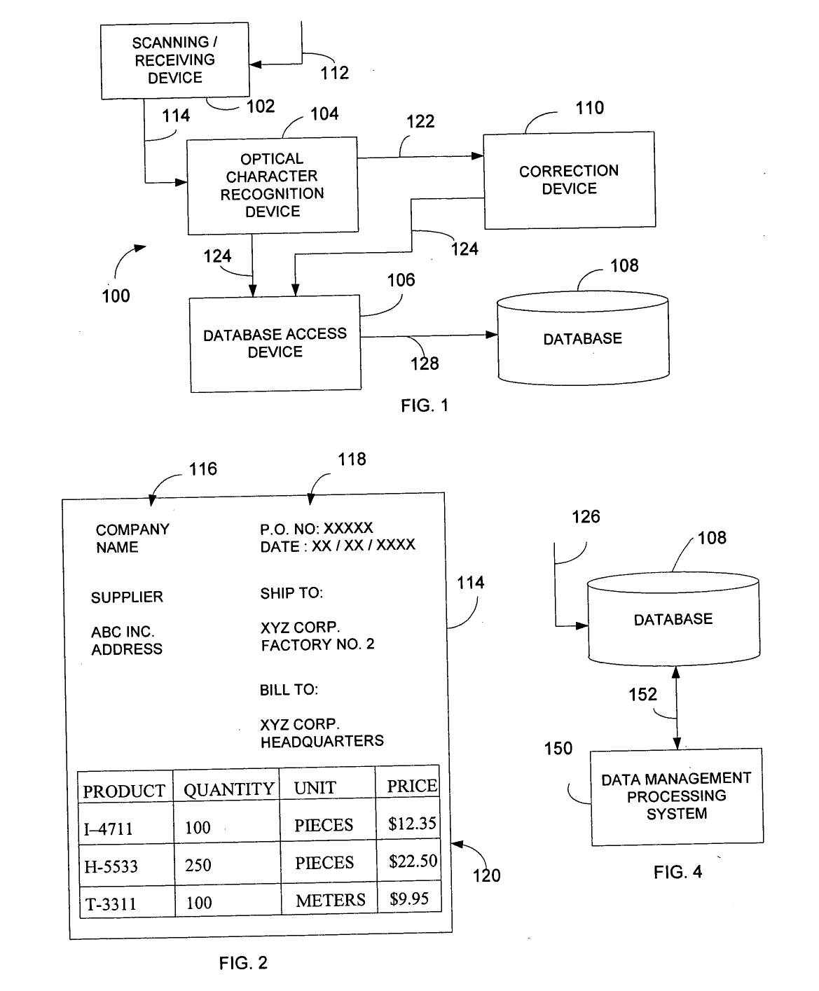

More specifically, FIG. 1 illustrates a system 100 for automating data processing. The system 100 includes a scanning/receiving device 102, an optical character recognition (OCR) device 104, a database access device 106 and a database 108. In one embodiment, the system further includes a correction device 110.

The scanning/receiving device 102 may be any suitable device capable of receiving an incoming document, which may be either in a physical or electronic format. For example, the scanning/receiving device 102 may be a scanner capable of scanning a physical document and generating an electronic representation of the physical document in electronic format, in accordance with known scanning technologies. In another embodiment, the scanning/receiving device may be a communication server operative to receive incoming electronic communications, such as a facsimile server receiving incoming facsimiles or an electronic mail server receiving incoming electronic mail communications.

The OCR device 104 may be one or more processing devices executing OCR operations in accordance with known OCR technology. Furthermore, the OCR device includes operations to parse out specific elements from the electronic document.

The database access device 106 may be one or more processing devices executing instructions to access the database 108. As discussed in further detail below, the database access device 106 provides for the storage of data and the electronically formatted input document in the database 108.

The database 108 may be any suitable database allowing for the storage of and retrieval therefrom of data. In one embodiment, the database 108 may be associated with one or more processing applications allowing for multi-party access to the database. For example, the database 108 may be an Enterprise Resource Planning (ERP) database.

The correction device 110 may be one or more processing devices allowing for the operation of corrective actions. As discussed in greater detail below, the correction device 110 allows for further inspection of the input document when not recognizable by the OCR device 104. In one embodiment, the correction device may include an output display screen and an input device allowing for a user to view the electronic document and manually enter the data from the document. For example, the incoming document may be an unrecognizable facsimile, with letters and numbers unrecognizable by the OCR device 104, but readable by the human eye.

In one embodiment, the scanning/receiving device 102 receives an input document 112. If the input document 112 is an electronic document, the scanning/receiving device 102 extracts the document from any accompanying transmissions, such as if the document is an attachment to an electronic mail. After extraction, or if no extraction is needed, such as with a facsimile, an input file 114 is provided to the OCR device 104. The input file 114 is the electronic representation of the input document 112.

The OCR device 104 thereupon performs OCR operations on the input file 114. In performing the recognition operations, the OCR device 104 extracts the specific information. For example, FIG. 2 illustrates a representative example of an input file 114 having header information 116, purchase ordering information 118 and purchase request information 120. The OCR device 104 performs the character recognition to extract this information. In this example, the input file 114 may be a response to an order request form, wherein the form originally included suggested purchasing information and the received form includes altered terms in accordance with the purchaser's request.

In one embodiment, the OCR device generates input data including the information obtained from the input file 114. The input data may also include information acquired through the examination of additional information, for example such as header information, telephone number caller identifiers, electronic mail addresses.

In one embodiment, a determination may be made if the OCR device 104 is capable of recognizing the input document 114. Using existing OCR technology, the device 104 is capable of determining if the document 114 has been properly recognized. Based on this decision, the correction device 110 may be used for correction.

Where the correction device 110 is used, the OCR device 104 receives an unrecognizable input file 122, where the unrecognizable input file 122 is the input file 114 that the OCR device 104 was unable to recognize. In one embodiment, the correction device 110 may include input/output technologies allowing a user to visually inspect and manually enter the input data from the electronic file. In another embodiment, the correction device 110 may include one or more further refined OCR technologies allowing for a higher degree of OCR and allowing for a user to visually verify and/or correct the input data.

Whether the OCR device 104 recognizes the input file 114 or the correction device 110 is used, the input data 124 is thereupon provided to the database access device 106. The database access device 106 also receives the input file 114, such as from the OCR device 104 which is included with the input data 124.

The database access device 106 accesses the database 108 using the input data 124, including mapping and matching data with the data in the database 108. For example, if the input data 124 indicates the input file 114 is directed to a particular customer, the database access device 106 accesses the database with this information. Using the information recognized from the input file, a particular data field may be accessed and the data in the field updated. For example, in the embodiment with the purchase order response, the original purchase order request may be stored in the database 108, and the input data 124 is mapped to the data field, matching the data for updating the terms in the data field. In one embodiment, the database access device 106 also provides for the storage of the input file 114 to the database 108. The storage may be based on the input data 124 or may be stored in any suitable location as determined by the database 108. Although, when the input file 114 is stored in the database 108, the storage location 126 is provided to the database access device 106. This storage location 126 may be indicated by an active link to this stored document.

The database access device 106 thereupon provides the input data and active link 126 to the database 108. The database access device 106 includes functionality associated with the database 108 so that the input data and active link 126 may be formatted congruent with data formatting in the database 108. For example, the input data and active link data 126 may be formatted as an entry into the database 108 or updating the information in an existing data field, such as referenced by a purchase order number.

In the example of a purchase order response, the input data 124 may be the data associated with the response, such as illustrated in FIG. 2. The input data 124 may be used to create an entry or update an entry in a purchasing database system, as well as an entry in a supplier relationship management database system. The automated process provides for generating data entries for the defined customer, including purchase order requests, and responses, as well as financial and delivery information. A salesperson may seamlessly access the database 108 to see the order request.

Additionally, the purchase order information may be provided to an inventory management database. An inventory specialist may access the database to determine the present order requests for particular items. In accordance with further known database technology, the information may also be readily available for any searching or other overview operations.

As may be required by laws, rules, customs or regulations, it is also important to keep copies of the original documents. Therefore, it is important to not only save the electronic format of the documents, but make them readily accessible in conjunction with the database entries.

Existing technology allows active or hyper linking operations for providing an address or pointer to the stored document. Therefore, including the link in the database entry provides for a higher level of usability, improved efficiency by making the documents readily available and improved security by allowing for the immediate examination of original documents in the event of any discrepancies.

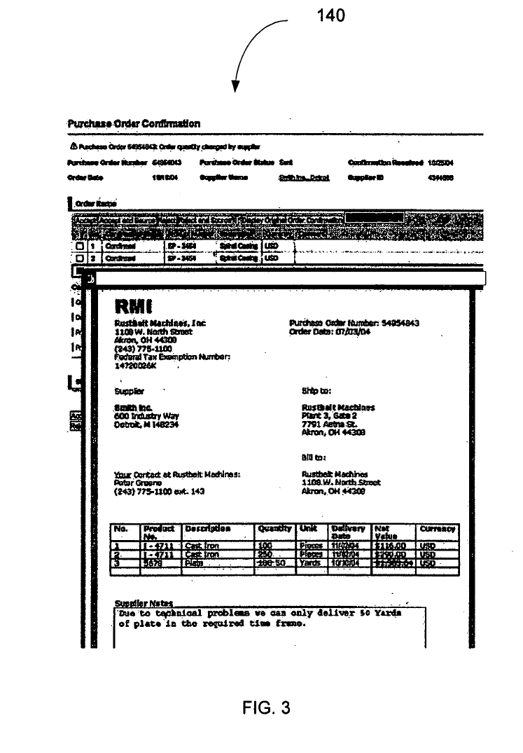

FIG. 3 illustrates a screen shot of a database entry 140. The entry 140 includes a tabular listing of orders, order numbers 1 and 2 visible in the table. Above the table is the general information relating to the entry, such as ordering information and supplier information. The table entries include active links allowing for the immediate retrieval and display of the original document. In the screen shot of FIG. 3, a letter 142 was received, recognized and stored in the database. Using the link associated with the data, the electronic representation of the letter 142 is viewable. Therefore, within the database itself, the information is readily viewable and usable for verification and other reasons. The electronic representation of the original document is also available.

FIG. 4 illustrates a further embodiment of the system for automated data processing. In addition to accessing the database, the system includes backend applications accessing the database to use the data stored therein.

Generally described as a data management processing system 150, the data management processing system 150 may be any suitable number of applications in communication 152 with the database. The data management processing system 150 includes processing devices retrieving the information and using the information for associated functions, as recognized by one having ordinary skill in the art. For example, the data management processing system may be an inventory application operative to retrieve order information from the database. Using this order information, the inventory application may determine if there is an adequate supply of inventory. In another example, the data management processing system may be a sales application using the data within the database for sales forecasting or reporting purposes.

Regardless of the specific application(s) executing on the data management processing system 150, the system 150 has backend access to the database 108. The database 108 is populated with specific information as described above, such as with respect to FIG. 1. Therefore, the populating of the database 108 with data using OCR technology in conjunction with the database access device 106 of FIG. 1 is transparent to the data management processing system 150. Although, in one embodiment as further level of functionality, the data management processing system 150 allows for the access to the original electronic document using any suitable available means.

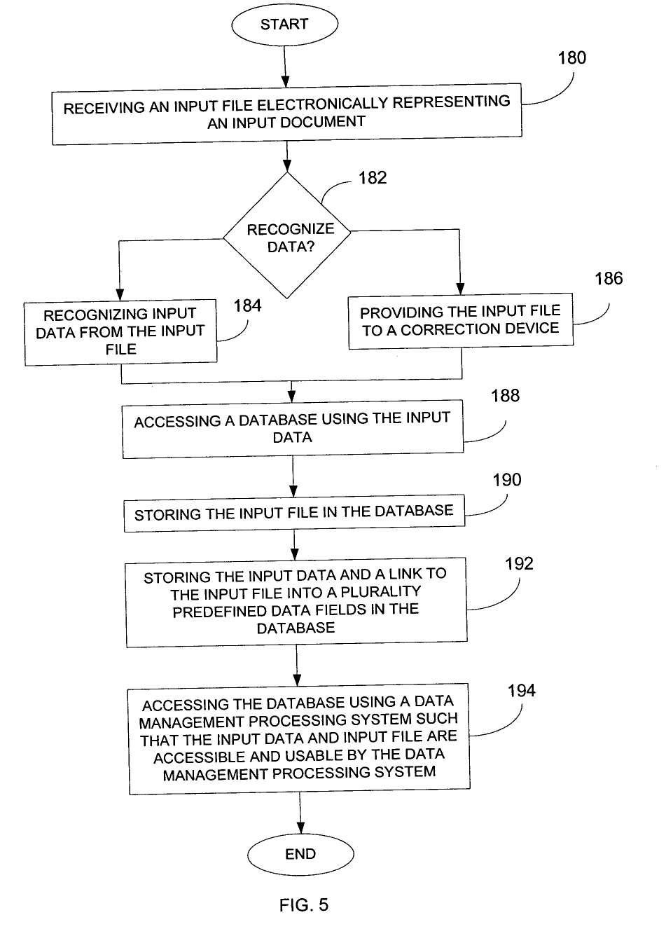

FIG. 5 shows the steps of one embodiment of a method for automating data processing. The method begins by receiving an input file electronically representing an input document, step 180. In one example, the input file may be an electronic representation of an incoming facsimile. Whereas, the incoming facsimile is spooled to a facsimile server and typically printed out, the electronic file may be presented directly to a device for performing OCR.

The next step, step 182, is determining if the OCR device can recognize the data. Due to technological limitations, some electronic documents may be unrecognizable. Using the example of the incoming facsimile, sometimes the numbers and text on the document are distorted due to the quality of the transmitting facsimile machine. Existing OCR technology allows the OCR device to determine the accuracy of the recognition and therefore determine if the recognition is within a defined quality threshold level.

In the event the data on the document can be recognized, the method proceeds to step 184, which is recognizing the input data from the input file. This step is performed in accordance with known OCR technology and further includes parsing out the information into predefined categories, such as categories described by a device for accessing the database or predefined parameters included within the OCR technology.

With respect to the decision at step 182, in the event the data cannot be recognized, the method proceeds instead to step 186 which is providing the input file to a correction device. As described above with respect to FIG. 1, in one embodiment the correction device may be a workstation having an output display for displaying the unrecognizable electronic document and an input device for receiving user input of the data itself. The correction device may utilize a person to physically inspect and directly enter the information in the event the recognition technology is ineffective, thereby allowing the further benefits of the automated data processing even for the unrecognizable document. In one embodiment, the correction device may include a storage location for queuing any number of unrecognizable documents so that a user may occasionally utilize the correction device to clear the queue.

Whether the data was recognized using the OCR device, step 184, or with the help of the correction device, step 186, the next step, step 188, is accessing a database using the input data. In the example of an incoming facsimile transmission, the data is recognized and parsed out. The information may include customer information and an order reference number. Using the input data, for example the customer information and the order reference number, the database access device may properly seek the corresponding data location.

The next step, step 190, is storing the input file in the database. This step may be performed in accordance with known data storage techniques. For example, the input file may already be in or converted to a defined file type and then stored either in a general location or a specified data storage location, available for access and/or retrieval. When storing the input file in the database, a link is generated providing a pointer for either retrieving or accessing the stored input file.

The next step, step 192, is storing the input data and the link to the input file into a plurality of predefined data fields in the database. In this step, the database access device stores the information so that it is associated with the proper element. For example, if the electronic document is a purchase order response, the order information is stored in the database associated with the particular customer. As discussed above with respect to FIGS. 1-2, in the embodiment of the purchase order response, the database access device matches the data with preexisting data in the database, such as a purchase order, the proper data field is matched and the data is mapped thereto within the database. The information may also be associated with a particular salesperson, an inventory application or any other associated field.

The information is populated into the database in accordance with the database operations. Whereas previous data entry may have been done with a user manually entering information, the database access device populates the fields by placing the information parsed out in the specific entries and ready for disposition therein. For example, if the data entry includes all the customer information and order information, the data is parsed out of having the customer information ready for data population and the order information is parsed and also ready for population. Whereupon, to the database, the input of information is seamless and the resultant data stored therein consistent with the previous data entry techniques.

The next step, step 194, is accessing the database using a data management processing system such that the input data and the input file are accessible and usable by the data management processing system. For example, such as illustrated above in FIG. 4, the data management processing system may be any suitable system, such as, but not limited to, an ERP system, an inventory system, a sales system, a data management system. Whereupon, similar to the screen shot of FIG. 3, a user may access the database 108 in accordance with known and standard database access techniques. Although, upon accessing the database, the user may readily see the data that has been automatically inserted into the database. Moreover, the user is presented with an active link to the actual electronic document stored therein.

Thereupon, in this embodiment, the method is complete. In the method, an electronic version of the input document is recognized, the information parsed out and stored in a centrally accessible database. Based on the parsing, storage and functionality within the database, the data is readily accessible and usable for any suitable database operation.

Although the preceding text sets forth a detailed description of various embodiments, it should be understood that the legal scope of the invention is defined by the words of the claims set forth below. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should be understood that there exists implementations of other variations and modifications of the invention and its various aspects, as may be readily apparent to those of ordinary skill in the art, and that the invention is not limited by specific embodiments described herein. For example, the electronic version of the input file may be stored in any suitable location, including external to the database and does not have to be stored before matching and mapping the data to the database, wherein a link to the stored input file may be referenced in the database as any suitable time. It is therefore contemplated to cover any and all modifications, variations or equivalents that fall within the scope of the basic underlying principals disclosed and claimed herein.

What is claimed is:

1. A system for automating data processing comprising:
an optical character recognition (OCR) device coupled to receive an input file electronically representing an input document, the OCR device recognizing input data from the input document;
a database access device coupled to receive the input data from the OCR device; and
a database coupled to the database access device, the database access device accessing the database using the input data to store the input file in the database and store the input data and a link to the input file into a plurality of predefined data fields in the database.

2. The system of claim 1 further comprising:
a scanning device generating the input file from a physical document, the input file provided to the OCR device.

3. The system of claim 1 further comprising:
a facsimile server receiving the input file from an incoming facsimile transmission, the input file provided to the OCR device.

4. The system of claim 1 further comprising:
an electronic mail distribution server receiving the input from an incoming electronic mail message, the input file provided to the OCR device.

5. The system of claim 1 further comprising:
a correction device coupled to the OCR device, the correction device coupled to receive an unrecognizable input file from the OCR device when the OCR device is unable to recognize the input data from the input document.

6. The system of claim 5, the correction device including:
an output display for providing a visual representation of the input file; and
an input device for receiving user input of the input data.

7. The system of claim 6 further comprising:
the correction device coupled to the database access device for providing the input data to the database access device.

8. The system of claim 1 wherein the database is an enterprise resource planning database.

9. The system of claim 1 further comprising:
a data management processing system coupled to the database such that the input data and the input file are accessible and usable by the data management processing system.

10. A method for automating data processing comprising:
receiving an input file electronically representing an input document;
recognizing input data from the input file;
accessing a database using the input data;
storing the input file in the database; and
storing the input data and a link to the input file into a plurality of predefined data fields in the database.

11. The method of claim 10 further comprising:
when the input data from the input file cannot be recognized, providing the input file to a correction device.

12. The method of claim 11 further comprising:
providing an output display of the of the input file; and
receiving user input representing the input data.

13. The method of claim 10 further comprising:
receiving the input file from a scanning device.

14. The method of claim 10 further comprising:
receiving the input file from a facsimile server.

15. The method of claim 10 further comprising:
receiving the input file from an electronic mail distribution server.

16. The method of claim 10 wherein the database is an enterprise resource planning database.

17. The method of claim 10 further comprising:
accessing the database using a data management processing system such that the input data and the input file are accessible and usable by the data management processing system.

18. A processing system allowing for automated data processing, the processing system comprising:
at least one processing device operative to execute executable instructions such that the at least one processing device is operative to:
receive an input file electronically representing an input document;
recognize input data from the input file;
when the input data from the input file cannot be recognized, provide the input file to a correction device;
access a database using the input data;
store the input file in the database; and
store the input data and a link to the input file into a plurality of predefined data fields in the database.

19. The processing system further comprising:
the at least one processing device further, in response to the executable instructions, operative to:
when the input file is provided to the correction device, provide an output display of the input file and receive user input representing the input data.

20. The processing system of claim 18 further comprising:
the at least one processing device further, in response to the executable instructions, operative to:
receive the input file from a scanning device, a facsimile server and an electronic mail distribution server.

21. The processing system of claim 18 wherein the database is an enterprise resource planning database.

22. The processing system of claim 18 further comprising:
the at least one processing device further, in response to the executable instructions, operative to:
accessing the database using a data management processing system such that the input data and the input file are accessible and usable by the data management processing system.

23. A system for automated data processing comprising:
a document input device receiving an input document;
an optical character recognition (OCR) device coupled to receive an input file electronically representing the input document from the document input device, the OCR device recognizing input data from the input document;
a correction device coupled to the OCR device, receiving an unrecognizable input file from the OCR device when the OCR device is unable to recognize the input data from the input document, the correction device generating the input data from the input document when the input data cannot be generated by the OCR device;
a database access device receiving the input data;
a database coupled to the database access device, the database access device accessing the database using the input data to store the input file in the database and store the input data and a link to the input file into a plurality of predefined data fields in the database; and
a data management processing system coupled to the database such that the input data and the input file are accessible and usable by the data management processing system.

24. The system of claim 23 further comprising:
the document input device is at least one of: a scanning device, a facsimile server and an electronic mail distribution server.

25. The system of claim 23, the correction device including:
an output display for providing a visual representation of the input file; and
an input device for receiving user input of the input data.

26. The system of claim 23 wherein the database is an enterprise resource planning database.
